(19) United States
(12) Patent Application Publication
(10) Pub. No.: US 2011/0042017 A1
(43) Pub. Date: Feb. 24, 2011

(54) ELECTRICAL CONTROL MECHANISM FOR BUILT-IN SUNSHADE PRODUCTS FOR HOLLOW GLASS

(76) Inventor: Renzhe JIN, Qinhuangdao (CN)

Correspondence Address: PILLSBURY WINTHROP SHAW PITTMAN, LLP, P.O. BOX 10500, MCLEAN, VA, 22102, US

(21) Appl. No.: 12/765,479

(22) Filed: Apr. 22, 2010

(30) Foreign Application Priority Data
Aug. 19, 2009 (CN) 200910168571.5

(51) Int. Cl. E06B 9/264

(52) U.S. Cl. 160/107

(57) ABSTRACT

The present invention discloses an electrical control mechanism for a built-in sunshade product for a hollow glass. The electrical control mechanism a handle disposed outside the hollow glass and a sliding block disposed within the hollow glass, the handle and the sliding block are provided with magnets therein and being attracted to each other via magnetic force of the magnets, a transmission mechanism disposed outside the hollow glass and coupled to a motor to drive said handle to move up and down; and a control device for controlling the motor and the transmission mechanism The control mechanism further includes a remote controller or/and a manual controller. The sunshade product according to the present invention can overcome the difficulty of operating a manually controlled built-in sunshade product for a hollow glass which is mounted at a high location. Meanwhile, the motor and the control circuit are disposed outside the hollow glass, so that the maintenance thereof becomes possible and convenient.

### BACKGROUND OF THE INVENTION

1. Field of the Invention

The present invention relates to a built-in sunshade product for a hollow glass, more particularly, to an electrical control mechanism for a louver (curtain) and a foldable curtain installed within the hollow glass.

2. Description of the Related Art

For the demands of the environmental protection, energy saving and comforts of life, the sunshade products are broadly used. The louver (curtain) and the foldable curtain are commonly used on the indoor window. Due to the special characteristics of the hollow glass, such as thermo insulating property, sound insulation property, anti glazed frost, dust and pollution proofing and the likes, through the development over more than one hundred years, the hollow glass becomes widely used throughout the world. Chinese Patents ZL03238471.8 (patent family in US is U.S. Pat. No. 7,124,803 B2), ZL200320128533.5, ZL200420057384.2 and so on applied by the same applicant of the present invention are related to the louver built within the hollow glass, which belongs to one of built-in sunshade products for the hollow glass.

FIGS. 1A and 1B are the structural schematic views of the drawings of the patent ZL200420057384.2 titled “louver within the hollow glass” and filed on Dec. 15, 2004 by the Applicant to the SIPO. As shown in FIGS. 1A and 1B, the hollow glass with the louver is composed of supporting frames 24, 25, an outdoor side glass 23, an indoor side glass 23A, and a plurality of slats 21. As shown in FIGS. 1A and 1B, the hollow glass with the louver further includes elevating ropes 10, 12, ladder ropes 3, 5, a weight bottom beam 20, an elevating mechanism, a slat turning mechanism and the likes, such configuration facilitates the operations of elevation, opening, closing and the likes of the louver, and the operation principles will he omitted herein for purpose or brevity.

As shown in FIG. 1C, the slat turning operation handle 51 and the slat turning sliding block 26, as well as the elevating operation handle 52 and the elevating sliding block 13 are respectively disposed at outside and inside of the indoor side glass 23A, and are provided with magnets 15A and 15B mounted therein. The magnetic line of force passes through the glass so that the magnets 15A and 15B are attracted to each other. The slat turning operation handle 51 and the elevating operation handle 52 are respectively operated to move up and down, the magnets 15A move to actuate the magnets 15B under the action of the magnetic force, and thus the slat turning rope 7 or the elevating ropes 10, 12 are easily driven to perform the operations of the elevation, opening, closing and the likes of the louver. The operation principles thereof are the common knowledge and are not described herein.

However, in the above known techniques, it adopts manual operations which entails the usage of the sunshade louver inconvenient. The present invention provides an electrically controlled louver and a foldable curtain used in a hollow glass, which has reasonable contrivance and can be operated easily and reliably.

### SUMMARY OF THE INVENTION

Accordingly, an object of the present invention is to provide an electrical control mechanism for a built-in sunshade product for a hollow glass. With an electrical control manner, control buttons for the product can be disposed at a location where operation can be easily carried out or a remote control manner can be employed for the product.

According to an aspect of the present invention, the present invention provides an electrical control mechanism for a built-in sunshade product for a hollow glass. The electrical control mechanism comprises a control device, a transmission mechanism, a handle disposed outside the hollow glass and a sliding block disposed within the hollow glass. The control device is a remote controller or/and a manual controller; the transmission mechanism is disposed outside the hollow glass to drive said handle to move up and down by means of the rotation of a motor; and said handle and said sliding block are provided with magnets therein and are attracted to each other by virtue of the magnetic force.

The transmission mechanism includes a screw rod having one end coupled with the motor and another end passing through and engaging with said handle, the motor drives the screw rod to rotate, and the handle moves up and down along the screw rod by rotation of the screw rod.

The transmission mechanism includes a synchronous toothed belt and two synchronous toothed belt pulleys, said synchronous toothed belt is engaged with the two upper and lower synchronous toothed belt pulleys; said handle is fixed on the synchronous toothed belt and disposed between said two synchronous toothed belt pulleys. The synchronous toothed belt is driven to move around said synchronous toothed belt pulleys by the motor, and the handle is moved up and down by the movement of the synchronous toothed belt. The handle is fixed to the belt by gluing or other fixing connection methods.

The transmission mechanism includes a gear, a rack and a guiding rail being fixed parallel to each other, the handle, the gear and the motor are connected to be integrated together and constrained in a space formed by the guiding rail and the gear. The gear is co-axial with the motor and engaged with the rack. The motor drives the gear to rotate, accordingly, the handle moves up and down along the rack by the motor. Both the handle and the motor are mounted on a mounting board. A circuit board for driving the motor in the control device may be disposed on the handle or the mounting board.

The sunshade product according to the present invention has the following advantages. The sunshade product can overcome the difficulty of operating a manually controlled built-in sunshade product for a hollow glass which is mounted at a high location. On the other hand, the motor and the control circuit are provided outside the hollow glass, so that the maintenance thereof becomes possible and convenient.

### BRIEF DESCRIPTION OF THE DRAWINGS

FIGS. 1A and 1B are structural schematic views showing a conventional louver within a hollow glass;

FIG. 1C is a side view of the conventional louver within the hollow glass;

FIG. 2 is a schematic view showing an electrical control mechanism for a louver installed within a hollow glass according to a first embodiment of the present invention;

FIG. 3A is a schematic view showing an electrical control mechanism for a louver installed within a hollow glass according to a second embodiment of the present invention;

FIG. 3B is a schematic side view of FIG. 3A;

FIG. 4A is a schematic view showing an electrical control mechanism for a louver installed within a hollow glass according to a third embodiment of the present invention; and

FIG. 4B is a schematic side view of FIG. 4A.

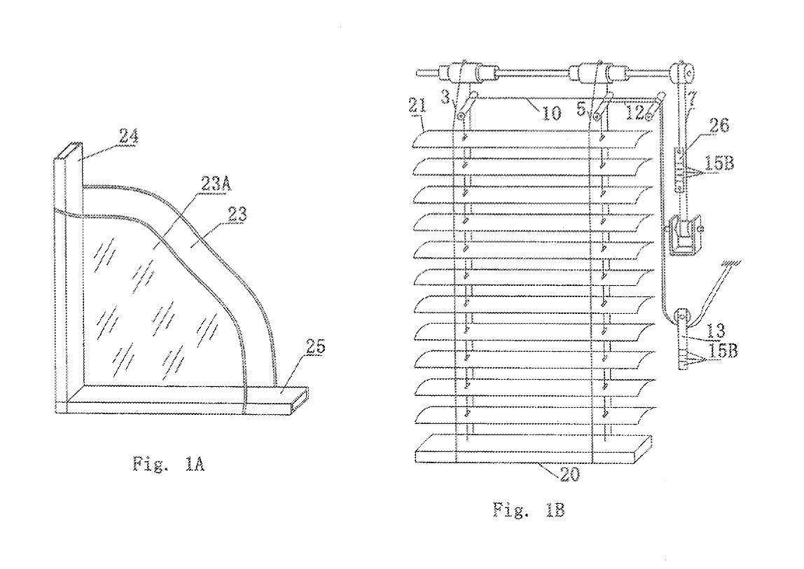

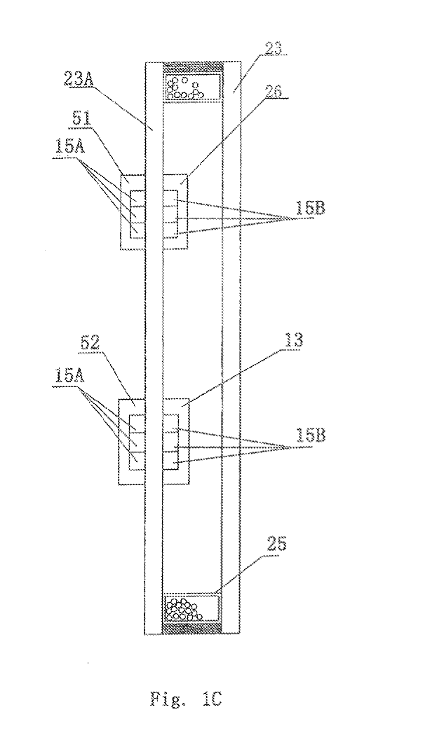

### DETAILED DESCRIPTION OF THE EMBODIMENTS

Embodiments of the present invention will be described hereinafter in detail with reference to the attached drawings, wherein the like reference numerals refer to the like elements throughout the specification. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

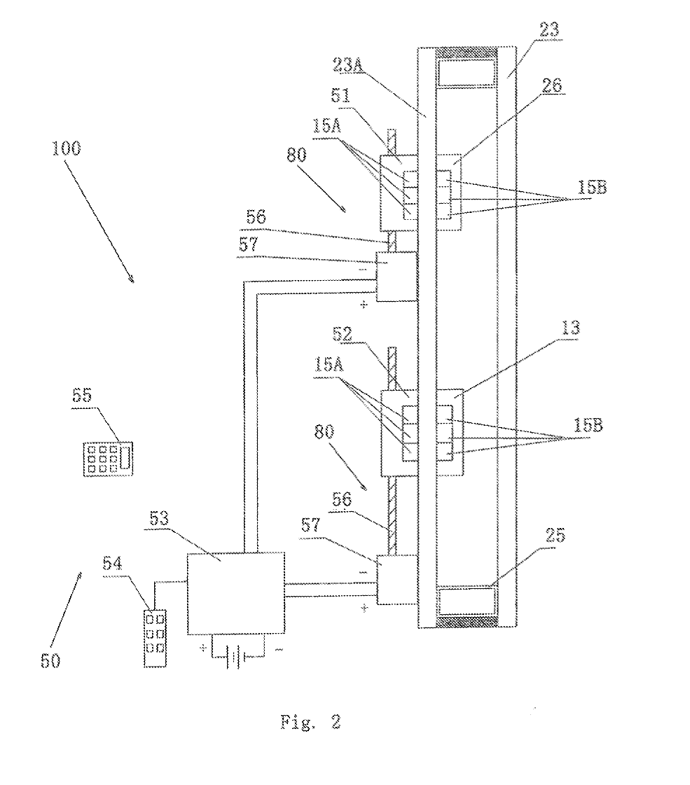

FIG. 2 is a schematic view showing an electrical control mechanism for a louver installed within a hollow glass according to a first embodiment of the present invention. As shown in FIG. 2, the electrical control mechanism 100 for a built-in sunshade product for a hollow glass comprises a control circuit 50, a motor 57, a screw rod 56 and handles 51 and 52. The control circuit 50 includes a remote controller 55, and/or a manual control button panel 54, and a control circuit board 53. A circuit for receiving instruction transmitted from the remote controller 55 is provided in the control circuit board 53. The control circuit board 53 controls the rotation of the motor 57. In the embodiment, the motor 57 can he controlled by using both the remote controller 55 and the manual control button panel 54. The handles 51 and 52 include a slat turning operation handle 51 and an elevating operation handle 52. The slat turning operation handle 51 is attracted together with a slat turning sliding block 26 though the magnetic force. The elevating operation handle 52 is attracted together with an elevating sliding block 13 through the magnetic force. The control manners for controlling the slat turning operation handle 51 and the elevating operation handle 52 are the same in the embodiment, and the elevating operation handle 52 being taken as the example is described as follows.

A transmission mechanism 80 of the embodiment comprises a screw rod 56 having one end passing through the elevating operation handle 52. Thread is provided in the elevating operation handle 52 for engaging with the screw rod 56, so that the elevating operation handle 52 is movable up and down along the screw rod 52 by rotation of the screw rod 56. The other end of the screw rod 56 is coupled with the motor 57. When the motor 57 rotates, the screw rod 56 is driven to rotate in positive forward direction or a reverse direction.

The motor 57 may be set in advance in such a manner that the motor 57 drives the screw rod 56 to rotate in a forward direction when it rotates in the forward direction, and the motor 57 drives the screw rod 56 to rotate in a reverse direction when the motor 57 rotates in the reverse direction. When using the built-in sunshade product for the hollow glass, if a user wants to open the sunshade product, the motor 57 is controlled by the control circuit to rotate, and the motor 57 drives the screw rod 56 to rotate so as to drive the elevating operation handle 52 to move up and down. As a result, the elevating sliding block 13 also moves up and down together with the elevating operation handle 52.

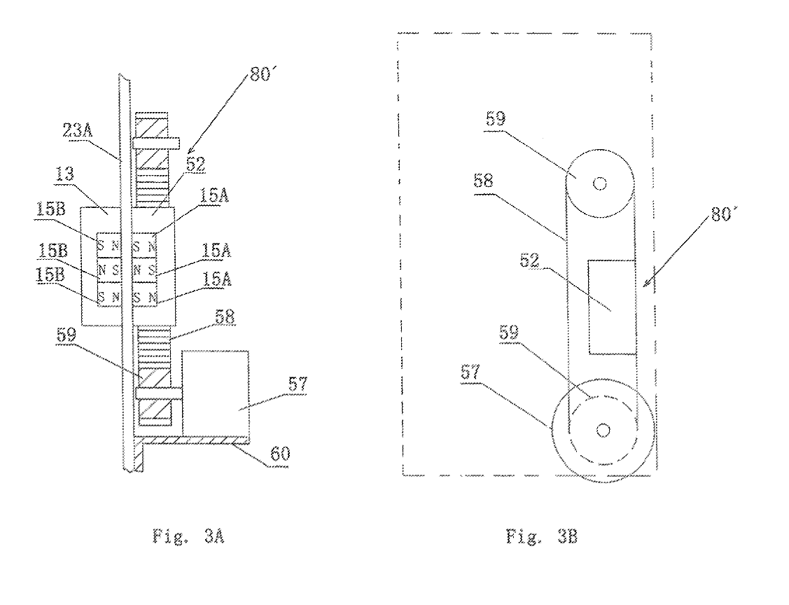

FIG. 3A is a schematic view showing an electrical control mechanism for a louver installed within a hollow glass according to a second embodiment of the present invention; and FIG. 3B is a schematic side view of FIG. 3A. The second embodiment differs from the first embodiment in that the handle is moved by a synchronous toothed belt 58 instead of the screw rod 56. As shown in FIGS. 3A and 3B, a transmission mechanism 80′ comprises the synchronous toothed belt 58 that forms an endless belt with teeth on its inner face. The transmission mechanism 80′ further comprises upper and lower synchronous toothed belt pulleys 59, which are mounted to be spaced from each other by a predetermined distance, and both of which have teeth on their outer circumferential surface. The synchronous toothed belt 58 is wrapped around and engaged with two synchronous toothed belt pulleys 59. The elevating operation handle 52 is fixed on the synchronous toothed belt 58 and disposed between the two synchronous toothed belt pulleys 59 so as to move up and down by the synchronous toothed belt 58 wrapped around the synchronous toothed belt pulleys 59. The elevating operation handle 52 is fixed on the synchronous toothed belt 58 by adhesion or gluing in the embodiment. The elevating operation handle 52 may he fixed on the synchronous toothed belt 58 by any other appropriate means.

The motor 57 is mounted on a mounting board 60 and is co-axial with one of the synchronous toothed belt pulleys 59. The motor 57 drives the one of synchronous toothed belt pulleys 59 to rotate, and thus the synchronous toothed belt 58 is driven to be rotated, so that the elevating operation handle 52 moves up and down together with the synchronous toothed belt 58. As a result, the elevating sliding block 13 also moves up and down together with the elevating operation handle 52.

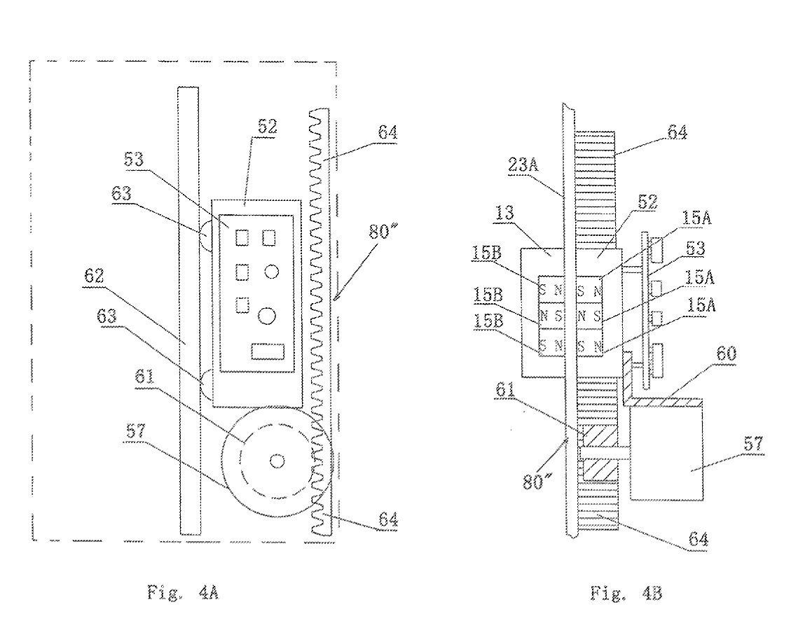

FIG. 4A is a schematic view showing an electrical control mechanism for a louver installed within a hollow glass according to a third embodiment of the present invention; and FIG. 4B is a schematic side view of FIG. 4A. The third embodiment is different from the first embodiment in that the handle is moved by using a rack 64 instead of the screw rod 56. As shown in FIGS. 4A and 4B, a transmission mechanism 80″ comprises the rack 64 fixed on a wall (not shown in the figures) and having a bar shape. The rack 64 is disposed vertically. The elevating operation handle 52 is integrally coupled with the motor 57 through a mounting member 60. The transmission mechanism 80″ further comprises a gear 61, which is co-axial with the motor 57, and engaged with the rack 64. The transmission mechanism 80″ further comprises a guiding wheel 63 for guiding the elevating operation handle 52. The guiding wheel 63 abuts against a guiding rail 62 parallel to the rack 64. The guiding rail 62 may be disposed independently or fixedly connected to the indoor side glass 23A. The control circuit board 53 of the present embodiment is mounted on the elevating operation handle 52 and electrically connected with the motor 57. When the motor 57 is controlled to rotate in the forward direction or in the reverse direction, the gear 61 is driven to rotate in a forward direction or in a reverse direction. The control circuit board 53 of the present invention may be mounted on the mounting member 60.

When in use, under the control of the control circuit 50, in a long and narrow space formed between the guiding rail 62 and the rack 64, the gear 61 is driven by the motor 57 to he rotated. Since the gear 61 is engaged with the rack 64, the elevating operation handle 52, the mounting member 60 and the motor 57, which are integrated, move up and down along the rack 64. The elevating sliding block 13 also moves up and down through the magnetic force generated by the magnets 15A and 15B.

Although only three embodiments are illustrated above, the elevating operation handle 52 or the slat turning operation handle 51 may move via a motor through a belt, chain wheel or the likes, so that the sliding blocks 13 or 26 within the glass move up and down.

It would he appreciated by those skilled in the art that many modifications, alterations and substitutions may he made in these embodiments without departing from the principles and spirit of the invention, the scope of which is defined in the claims and their equivalents.

1. An electrical control mechanism for a built-in sunshade product for a hollow glass, comprising:
a handle disposed outside the hollow glass and a sliding block disposed within the hollow glass, said handle and said sliding block being provided with magnets therein and being attracted to each other by magnetic force of the magnets,
a transmission mechanism disposed outside the hollow glass and coupled to a motor that are configured to drive said handle to move up and down;
a control device configured to control the motor and the transmission mechanism, the control mechanism including a remote controller, a manual controller, or both.

2. The electrical control mechanism for a built-in sunshade product for a hollow glass according to claim 1, wherein the transmission mechanism includes a screw rod having one end coupled to the motor and another end passing through and engaging with said handle, and wherein the motor drives the screw rod to rotate, and the handle moves up and down along the screw rod by the rotation of the screw rod.

3. The electrical control mechanism for a built-in sunshade product for a hollow glass according to claim 1, wherein said transmission mechanism includes a synchronous toothed belt and two synchronous toothed belt pulleys, said synchronous toothed belt is engaged with said two synchronous toothed belt pulleys disposed at upper and lower positions,
respectively, said handle is fixed on the synchronous toothed belt and disposed between said two synchronous toothed belt pulleys, the motor drives the synchronous toothed belt pulley to rotate and the synchronous toothed belt moves up and down, and the handle is moved up and down by the synchronous toothed belt.

4. The electrical control mechanism for a built-in sunshade product for a hollow glass according to claim 3, wherein said handle is fixed on the synchronous toothed belt by gluing.

5. The electrical control mechanism for a built-in sunshade product for a hollow glass according to claim 1, wherein said transmission mechanism includes a gear, a rack and a guiding rail being fixed parallel to each other, the handle, the gear and the motor are coupled to be integrated together and constrained in a space formed by the guiding rail and the rack, said gear is co-axial with the motor and engaged with the rack, the motor drives the gear to rotate, such that the handle moves up and down along the rack.

6. The electrical control mechanism for a built-in sunshade product for a hollow glass according to claim 5, wherein both the handle and the motor are mounted on a mounting member.

7. The electrical control mechanism for a built-in sunshade product for a hollow glass according to claim 5, wherein a circuit board of the control device is disposed on the handle or the mounting member.

8. The electrical control mechanism for a built-in sunshade product for a hollow glass according to claim 6, wherein a circuit board of the control device is disposed on the handle or the mounting member
